(19) United States
(12) Patent Application Publication
(10) Pub. No.: US 2013/0176004 A1
(43) Pub. Date: Jul. 11, 2013

(54) SWITCHING MODE POWER SUPPLY

(71) Applicants: Pengjie Lai, San Jose, CA (US); Jian Jiang, Los Gatos, CA (US); Eric Yang, Saratoga, CA (US)

(72) Inventors: Pengjie Lai, San Jose, CA (US); Jian Jiang, Los Gatos, CA (US); Eric Yang, Saratoga, CA (US)

(73) Assignee: Monolithic Power Systems, Inc., San Jose, CA (US)

(21) Appl. No.: 13/347,345

(22) Filed: Jan. 10, 2012

(51) Int. Cl. G05F 1/10

(52) U.S. Cl. 323/234

(57) ABSTRACT

The present disclosure discloses a switching mode power supply with constant peak current mode control. During the operation of the switching mode power supply, in one hand, the current flowing through a high-side switch is sensed and compared to a current reference signal to control the turning off of the high-side switch; in the other hand, the output voltage is sensed and compared to a voltage reference signal to control the turning on of the high-side switch. In addition, the current reference signal may be adjusted to a lower value when the switching mode power supply enters light load condition. By using the above control method, the system performance is highly increased.

### TECHNICAL FIELD

The present disclosure relates generally to electrical circuits, and more particularly but not exclusively to switching mode power supplies.

### BACKGROUND

Peak current mode control is widely used in switching mode power supplies due to fast transient response, over current protection, and etc. FIG. 1 schematically shows a conventional switching mode power supply 50 connected as shown. It realizes peak current mode control by comparing a current sense signal indicative of the inductor current with a compensation signal provided by an error amplifier 55, which is variable to an output voltage V_{O}. In addition, the conventional switching mode power supply 50 adopts a current limit comparator 59 to limit the inductor current in case the current sense signal goes high away from the compensation signal, and adopts an additional clock signal generator 57 to provide the clock signal, which complicates the design cost. The clock signal generator 57 also causes the frequency of the switching mode power supply 50 to be constant, which highly reduces the system efficiency when entering light mode.

### SUMMARY

It is an object of the present disclosure to provide a switching mode power supply, which solves the above problems.

In accomplishing the above and other objects, there has been provided, in accordance with an embodiment of the present disclosure, a switching mode power supply, comprising: an input port configured to receive an input signal; an output port configured to provide an output signal; a power stage having a first input terminal, a second input terminal, and an output terminal, the first input terminal being coupled to the input port to receive the input signal, the second input terminal being coupled to a driver to receive a driving signal, and based on the input signal and the driving signal, the power stage generates a switching signal at the output terminal; an inductor having a first terminal and a second terminal, the first terminal being coupled to the output terminal of the power stage to receive the switching signal, and the second terminal being coupled to the output port; an output capacitor coupled between the output port and a reference ground; a feedback unit coupled to the output port to generate a feedback signal indicative of the output signal; a voltage comparator having a first input terminal, a second input terminal, and an output terminal, wherein the first input terminal is coupled to the feedback unit to receive the feedback signal, the second input terminal is coupled to a voltage reference signal, and wherein based on the feedback signal and the voltage reference signal, the voltage comparator generates a voltage comparison signal at the output terminal; a current comparator having a first input terminal, a second input terminal, and an output terminal, wherein the first input terminal is configured to receive a current sense signal indicative of a current flowing through the power stage, the second input terminal is configured to receive a current reference signal, and wherein based on the current sense signal and the current reference signal, the current comparator generates a current comparison signal at the output terminal; a logic unit having a first input terminal, a second input terminal, and an output terminal, wherein the first input terminal is coupled to the output terminal of the voltage comparator to receive the voltage comparison signal, the second input terminal is coupled to the output terminal of the current comparator to receive the current comparison signal, and wherein based on the voltage comparison signal and the current comparison signal, the logic unit generates a logic signal at the output terminal; and the driver coupled to the logic unit to receive the logic signal, and wherein based on the logic signal, the driver generates the driving signal to control the power stage.

In addition, there has been provided, in accordance with an embodiment of the present disclosure, a switching mode power supply, comprising: an input port configured to receive an input signal; an output port configured to provide an output signal; a power stage having a first input terminal, a second input terminal, and an output terminal, the first input terminal being coupled to the input port to receive the input signal, the second input terminal being coupled to a driver to receive a driving signal, and based on the input signal and the driving signal, the power stage generates a switching signal at the output terminal; an inductor having a first terminal and a second terminal, the first terminal being coupled to the output terminal of the power stage to receive the switching signal, and the second terminal being coupled to the output port; an output capacitor coupled between the output port and a reference ground; a feedback unit coupled to the output port to generate a feedback signal indicative of the output signal; a voltage comparator having a first input terminal, a second input terminal, and an output terminal, wherein the first input terminal is coupled to the feedback unit to receive the feedback signal, the second input terminal is coupled to a voltage reference signal, and wherein based on the feedback signal and the voltage reference signal, the voltage comparator generates a voltage comparison signal at the output terminal; an off timer coupled to a logic unit to receive a logic signal, and wherein based on the logic signal, the off timer generates a minimum off time signal; a logic AND circuit having a first input terminal, a second input terminal, and an output terminal, wherein the first input terminal is coupled to the output terminal of the voltage comparator to receive the voltage comparison signal, the second input terminal is coupled to the off timer to receive the minimum off time signal, and wherein based on the voltage comparison signal and the minimum off time signal, the logic AND circuit generates a logic AND signal; a current comparator having a first input terminal, a second input terminal, and an output terminal, wherein the first input terminal is configured to receive a current sense signal indicative of a current flowing through the power stage, the second input terminal is coupled to a current reference signal, and wherein based on the current sense signal and the current reference signal, the current comparator generates a current comparison signal at the output terminal; the logic unit having a first input terminal, a second input terminal, and an output terminal, wherein the first input terminal is coupled to the output terminal of the logic AND circuit to receive the logic AND signal, the second input terminal is coupled to the output terminal of the current comparator to receive the current comparison signal, and wherein based on the logic AND signal and the current comparison signal, the logic unit generates the logic signal at the output terminal; and the driver coupled to the logic unit to receive the logic signal, and wherein based on the logic signal, the driver generates the driving signal to control the power stage

Furthermore, there has been provided, in accordance with an embodiment of the present disclosure, a method used in a switching mode power supply, comprising: comparing a feedback signal indicative of an output signal of the switching mode power supply with a voltage reference signal to generate a voltage comparison signal; comparing a current sense signal indicative of a current flowing through a high-side switch of the switching mode power supply with a current reference signal to generate a current comparison signal, the high-side switch being configured to couple a power supply supplying an input signal to a load of the switching mode power supply; using the voltage comparison signal to control the turning on of the high-side switch; and using the current comparison signal to control the turning off of the high-side switch.

### BRIEF DESCRIPTION OF THE DRAWINGS

FIG. 1 schematically shows a conventional switching mode power supply 50.

FIG. 2 schematically shows a switching mode power supply 100 in accordance with an embodiment of the present disclosure.

FIG. 3 schematically shows the waveforms of the current reference signal I_{ref}, the current sense signal Iₛₑₙₛₑ, the driving signal G_{S}, the output signal V_{O}, and the voltage reference signal V_{ref} under both continuous mode (CCM) and discontinuous mode (DCM) in the switching mode power supply 100 in FIG. 2.

FIG. 4 schematically shows the waveforms of the current reference signal I_{ref}, the current sense signal Iₛₑₙₛₑ, the driving signal G_{S}, the output signal V_{O}, and the voltage reference signal V_{ref} when the current reference signal I_{ref} is adjusted to a lower value under discontinuous mode (DCM) in the switching mode power supply 100 in FIG. 2.

FIG. 5 schematically shows a switching mode power supply 200 in accordance with an embodiment of the present disclosure.

FIG. 6 schematically shows a detailed configuration of the off timer 209 in the switching mode power supply 200 in FIG. 5 in accordance with an embodiment of the present disclosure.

FIG. 7 schematically shows a switching mode power supply 300 in accordance with an embodiment of the present disclosure.

FIG. 8 schematically shows a detailed configuration of the off timer 309 in the switching mode power supply 300 in FIG. 7 in accordance with an embodiment of the present disclosure.

FIG. 9 schematic shows a flowchart 400 of a method for a switching mode power supply in accordance with an embodiment of the present disclosure.

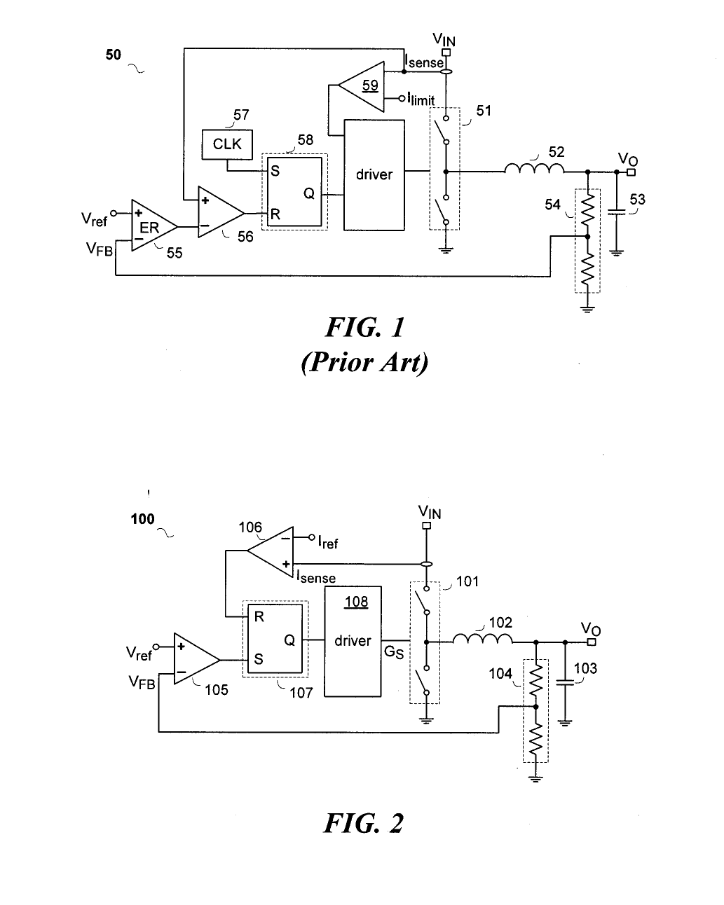

The use of the similar reference label in different drawings indicates the same of like components.

### DETAILED DESCRIPTION

In the present disclosure, numerous specific details are provided, such as examples of circuits, components, and methods, to provide a thorough understanding of embodiments of the disclosure. Persons of ordinary skill in the art will recognize, however, that the disclosure can be practiced without one or more of the specific details. In other instances, well-known details are not shown or described to avoid obscuring aspects of the disclosure.

FIG. 2 schematically shows a switching mode power supply 100 in accordance with an embodiment of the present disclosure. In the example of FIG. 2, the switching mode power supply 100 comprises: an input port configured to receive an input signal V_{IN}; an output port configured to provide an output signal V_{O}; a power stage 101 having a first input terminal, a second input terminal, and an output terminal, the first input terminal being coupled to the input port to receive the input signal V_{IN}, the second input terminal being coupled to a driver 108 to receive a driving signal G_{S}, and based on the input signal V_{IN} and the driving signal G_{S}, the power stage 101 generates a switching signal at the output terminal; an inductor 102 having a first terminal and a second terminal, the first terminal being coupled to the output terminal of the power stage 101 to receive the switching signal, and the second terminal being coupled to the output port; an output capacitor 103 coupled between the output port and a reference ground; a feedback unit 104 coupled to the output port to generate a feedback signal V_{FB} indicative of the output signal V_{O}; a voltage comparator 105 having a first input terminal, a second input terminal, and an output terminal, wherein the first input terminal is coupled to the feedback unit 104 to receive the feedback signal V_{FB}, the second input terminal is coupled to a voltage reference signal V_{ref}, and wherein based on the feedback signal V_{FB} and the voltage reference signal V_{ref}, the voltage comparator 105 generates a voltage comparison signal at the output terminal; a current comparator 106 having a first input terminal, a second input terminal, and an output terminal, wherein the first input terminal is configured to receive a current sense signal Iₛₑₙₛₑ indicative of a current flowing through the power stage, the second input terminal is configured to receive a current reference signal I_{ref}, and wherein based on the current sense signal Iₛₑₙₛₑ and the current reference signal I_{ref}, the current comparator 106 generates a current comparison signal at the output terminal; a logic unit 107 having a first input terminal, a second input terminal, and an output terminal, wherein the first input terminal is coupled to the output terminal of the voltage comparator 105 to receive the voltage comparison signal, the second input terminal is coupled to the output terminal of the current comparator 106 to receive the current comparison signal, and wherein based on the voltage comparison signal and the current comparison signal, the logic unit 107 generates a logic signal at the output terminal; and the driver 108 coupled to the logic unit 107 to receive the logic signal, and wherein based on the logic signal, the driver 108 generates the driving signal G_{S} to control the power stage 101.

In one embodiment, the power stage 101 comprises a high-side switch and a low-side switch coupled in series.

In one embodiment, the logic unit 108 comprises a RS flip-flop.

In one embodiment, the feedback unit 104 comprises a first resistor and a second resistor coupled in series between the output port and the reference ground; and the feedback signal V_{FB} is provided at the conjunction of the first resistor and the second resistor.

When the switching mode power supply 100 is in operation, in one hand, the output signal V_{O} is monitored by the feedback unit 104 to provide the feedback signal V_{FB} indicative of the output signal V_{O}. The feedback signal V_{FB} is then compared to the voltage reference signal V_{ref} by the voltage comparator 105. When the feedback signal V_{FB} goes lower than the voltage reference signal V_{ref}, the voltage comparison signal provided by the voltage comparator 105 turns to be logical high. Accordingly, the output of the logic unit 107 is set, which causes the high-side switch to be turned on, and the low-side switch to be turned off via the driver 108. As a result, both the output signal V_{O} and the current flowing through the high-side switch increase. In the other hand, the current flowing through the high-side switch is sensed to provide the current sense signal Iₛₑₙₛₑ indicative of the current flowing through the high-side switch. When the current sense signal Iₛₑₙₛₑ goes higher than the current reference signal I_{ref}, the current comparison signal provided by the current comparator 106 turns to be logical high. Accordingly, the output of the logic unit 107 is reset, which causes the high-side switch to be turned off, and the low-side switch to be turned on via the driver 108. As a result, both the output signal and the current flowing through the high-side switch decrease. When the output signal decreases to a certain value, which means the feedback signal V_{FB} becomes lower than the voltage reference signal V_{ref}, the logic unit 107 is set by the voltage comparison signal again, and the high-side switch is turned on, and the low-side switch is turned off via the driver 108. So the switching mode power supply 100 enters a new switching cycle, and operates as discussed above.

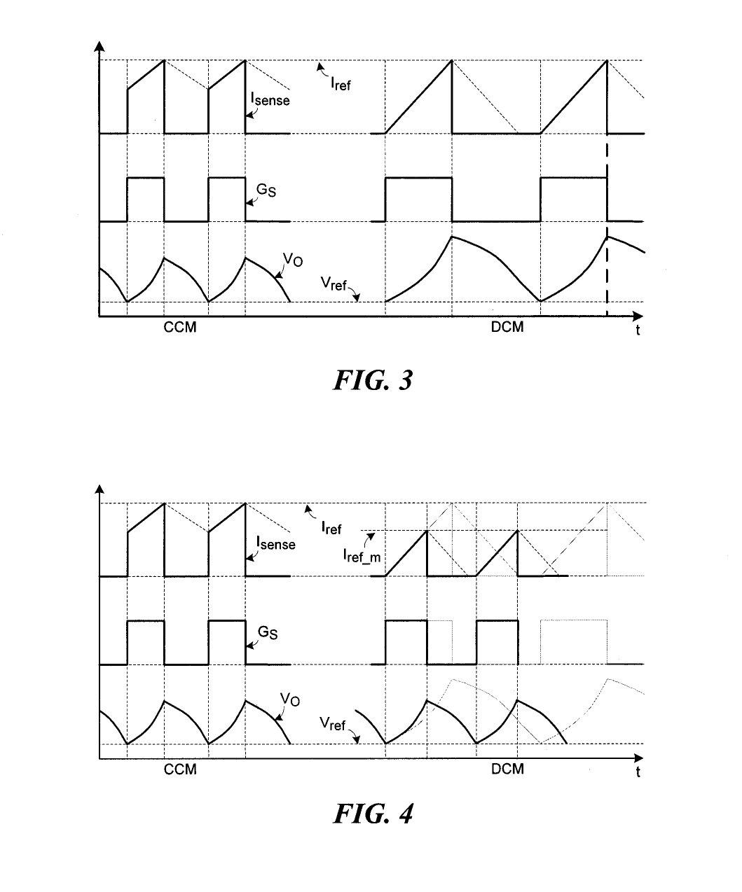

FIG. 3 schematically shows the waveforms of the current reference signal I_{ref}, the current sense signal Iₛₑₙₛₑ, the driving signal G_{S}, the output signal V_{O}, and the voltage reference signal V_{ref} under both continuous mode (CCM) and discontinuous mode (DCM) in the switching mode power supply 100 in FIG. 2.

As seen from FIG. 3, when the switching mode power supply 100 operates in discontinuous mode (DCM), which may mean the switching mode power supply 100 enters light load condition, the switching cycle becomes longer, i.e., the switching frequency is reduced, which improves the system efficiency.

In one embodiment, the current reference signal I_{ref} is adjustable. It may be adjusted to be a lower value to reduce the output voltage ripple when the switching mode power supply 100 enters light load condition. In one embodiment, when the current flowing through the low-side switch goes to zero, a zero-crossing signal is generated, which reduces the current reference signal I_{ref} to a lower value.

FIG. 4 schematically shows the waveforms of the current reference signal I_{ref}, the current sense signal Iₛₑₙₛₑ, the driving signal G_{S}, the output signal V_{O}, and the voltage reference signal V_{ref} when the current reference signal I_{ref} is adjusted to a lower value under discontinuous mode (DCM) in the switching mode power supply 100 in FIG. 2. As shown in FIG. 4, when the switching mode power supply 100 is under DCM, the current reference signal I_{ref} is adjusted to I_{ref}_{ₘ} which is lower than the original one to reduce the output voltage ripple and further increase the system performance.

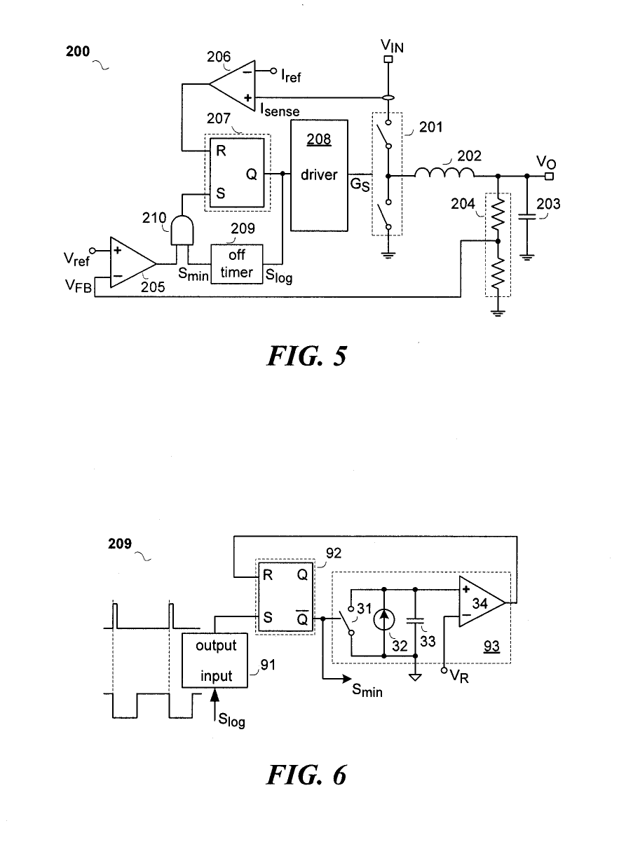

FIG. 5 schematically shows a switching mode power supply 200 in accordance with an embodiment of the present disclosure. The configuration of the switching mode power supply 200 in FIG. 5 is similar to the switching mode power supply 100 in FIG. 2. In the example of FIG. 5, the switching mode power supply 200 comprises: an input port configured to receive an input signal V_{IN}; an output port configured to provide an output signal V_{O}; a power stage 201 having a first input terminal, a second input terminal, and an output terminal, the first input terminal being coupled to the input port to receive the input signal V_{IN}, the second input terminal being coupled to a driver 208 to receive a driving signal G_{S}, and based on the input signal V_{IN} and the driving signal G_{S}, the power stage 201 generates a switching signal at the output terminal; an inductor 202 having a first terminal and a second terminal, the first terminal being coupled to the output terminal of the power stage 201 to receive the switching signal, and the second terminal being coupled to the output port; an output capacitor 203 coupled between the output port and a reference ground; a feedback unit 204 coupled to the output port to generate a feedback signal V_{FB} indicative of the output signal V_{O}; a voltage comparator 205 having a first input terminal, a second input terminal, and an output terminal, wherein the first input terminal is coupled to the feedback unit 204 to receive the feedback signal V_{FB}, the second input terminal is coupled to a voltage reference signal V_{ref}, and wherein based on the feedback signal V_{FB} and the voltage reference signal V_{ref}, the voltage comparator 205 generates a voltage comparison signal at the output terminal; an off timer 209 coupled to a logic unit 207 to receive a logic signal S_{log}, and wherein based on the logic signal, the off timer 209 generates a minimum off time signal Sₘᵢₙ; a logic AND circuit 210 having a first input terminal, a second input terminal, and an output terminal, wherein the first input terminal is coupled to the output terminal of the voltage comparator 205 to receive the voltage comparison signal, the second input terminal is coupled to the off timer 209 to receive the minimum off time signal Sₘᵢₙ, and wherein based on the voltage comparison signal and the minimum off time signal Sₘᵢₙ, the logic AND circuit 210 generates a logic AND signal; a current comparator 206 having a first input terminal, a second input terminal, and an output terminal, wherein the first input terminal is configured to receive a current sense signal Iₛₑₙₛₑ indicative of a current flowing through the power stage 201, the second input terminal is coupled to a current reference signal I_{ref}, and wherein based on the current sense signal Iₛₑₙₛₑ and the current reference signal I_{ref}, the current comparator 206 generates a current comparison signal at the output terminal; the logic unit 207 having a first input terminal, a second input terminal, and an output terminal, wherein the first input terminal is coupled to the output terminal of the logic AND circuit 210 to receive the logic AND signal, the second input terminal is coupled to the output terminal of the current comparator 206 to receive the current comparison signal, and wherein based on the logic AND signal and the current comparison signal, the logic unit 207 generates the logic signal S_{log} at the output terminal; and the driver 208 coupled to the logic unit 207 to receive the logic signal S_{log}, and wherein based on the logic signal S_{log}, the driver 208 generates the driving signal G_{S} to control the power stage 201.

In one embodiment, the power stage 201 comprises a high-side switch and a low-side switch coupled in series.

In one embodiment, the logic unit 208 comprises a RS flip-flop.

In one embodiment, the feedback unit 204 comprises a first resistor and a second resistor coupled in series between the output port and the reference ground; and the feedback signal V_{FB} is provided at the conjunction of the first resistor and the second resistor.

In one embodiment, the current reference signal I_{ref} is adjustable. It may be adjusted to be a lower value to reduce the output voltage ripple when the switching mode power supply 200 enters light load condition.

FIG. 6 schematically shows a detailed configuration of the off timer 209 in the switching mode power supply 200 in FIG. 5 in accordance with an embodiment of the present disclosure. In the example of FIG. 6, the off timer 209 comprises: a short pulse generator 91 configured to receive the logical signal S_{log} and generate a short pulse signal based thereupon; a second logic unit 92 having a first input terminal, a second input terminal, and an output terminal, wherein the first input terminal is coupled to the short pulse generator 91 to receive the short pulse signal, the second input terminal is configured to receive a minimum time preset signal, and based on the short pulse signal and the minimum time preset signal, the second logic unit 92 generates a second logic signal; a minimum time preset unit 93 having a first input terminal and a second input terminal, wherein the first input terminal is coupled to the output terminal of the second logic unit 92 to receive the second logic signal, the second input terminal is configured to receive a time reference signal V_{R}, wherein based on the second logic signal and the time reference signal V_{R}, the minimum time preset unit 93 generates the minimum time preset signal at the output terminal; and wherein the minimum off time signal Sₘᵢₙ is provided at the output terminal of the second logic unit 92.

In one embodiment, the second logic unit 92 comprises a RS flip-flop.

In one embodiment, the minimum time preset unit 93 comprises: a comparator 34 having a first input terminal, a second input terminal, and an output terminal, wherein the first input terminal is coupled to the time reference signal V_{R}; a reset switch 31, a current source 32, and a capacitor 33 coupled in parallel between the second input terminal of the comparator 34 and the reference ground to provide a voltage across the capacitor to the second input terminal of the comparator, wherein the comparator generates the minimum time preset signal at its output terminal based on the voltage across the capacitor and the time reference signal V_{R}; and wherein the reset switch 31 further having a control terminal coupled to the output of the second logic unit 92 to receive the second logic signal.

When the switching mode power supply 200 is in operation, the current flowing through the high-side switch is sensed to provide the current sense signal Iₛₑₙₛₑ indicative of the current flowing through the high-side switch. When the current sense signal Iₛₑₙₛₑ is higher than the current reference signal I_{ref}, the current comparison signal provided by the current comparator 206 turns to be logical high. Accordingly, the logic signal S_{log} provided by the logic unit 207 is reset to be low. In one hand, the short pulse generator 91 generates a short pulse signal in response to the falling edge of the logic signal S_{log}. Thus, the second logic signal provided by the second logic unit 92, i.e., the minimum off signal Sₘᵢₙ is low, which turns off the reset switch 31. Then the capacitor 33 is charged by the current source 32; and the voltage across the capacitor 33 increases. When the voltage across the capacitor 33 increases to be higher than the time reference signal V_{R}, the minimum time preset signal provided by the comparator 34 is high. Accordingly, the second logic signal, i.e., the minimum off time signal Sₘᵢₙ is high, which turns on the reset switch 31, and causes the voltage across the capacitor 33 to be reset to zero. Thus, the minimum off time signal Sₘᵢₙ is logical low for a preset time period which is determined by the current provided by the current source 31, the capacitance of the capacitor 33, and the time reference signal V_{R}. In the other hand, the low logic signal causes the high-side switch to be turned off, and the low-side switch to be turned on via the driver 208. As a result, both the output signal V_{O} and the current flowing through the high-side switch decrease. The output signal V_{O} is monitored by the feedback unit 204 to provide the feedback signal V_{FB} indicative of the output signal V_{O}. The feedback signal V_{FB} is then compared with the voltage reference signal V_{ref} by the voltage comparator 205. When the output signal V_{O} decreases to a certain value, i.e., the feedback signal V_{FB} is lower than the voltage reference signal V_{ref}, the voltage comparison signal provided by the voltage comparator 205 turns to be logical high. If the minimum off time signal Sₘᵢₙ is low at this time point, the logic AND signal provided by the logic AND circuit 210 is low as well. Until the minimum off time signal goes high after it pass the preset time period, the logic AND signal provided by the logic AND circuit 210 turns high. Accordingly, the logic signal S_{log} provided by the logic unit 207 is high, which causes the high-side switch to be turned on, and the low-side switch to be turned off via the driver 208. As a result, both the output signal V_{O} and the current flowing through the high-side switch increase. When the current flowing through the high-side switch increases to a certain value, that is, the current sense signal becomes higher than the current reference signal, the current comparison signal provided by the current comparator 206 is high. Accordingly, the logic signal S_{log} provided by the logic unit 207 is reset to be low, which turns off the high-side switch and turns on the low-side switch. And the switching mode power supply enters a new switching cycle, and operates as discussed above.

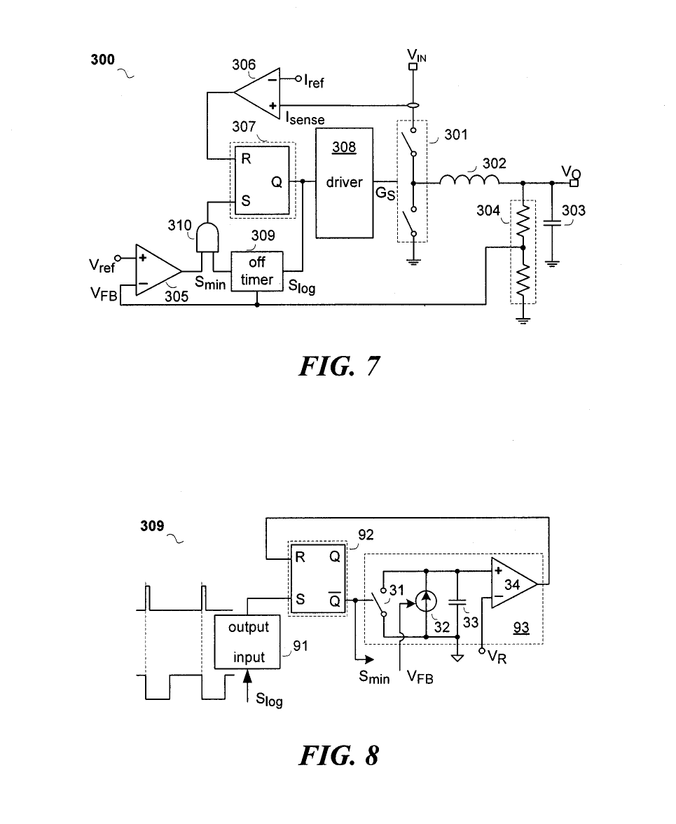

FIG. 7 schematically shows a switching mode power supply 300 in accordance with an embodiment of the present disclosure. The configuration of the switching mode power supply 300 in FIG. 7 is similar to the switching mode power supply 200 in FIG. 5. Different to the switching mode power supply 200 in FIG. 5, the off timer 309 in the switching mode power supply 300 further comprises a second input terminal coupled to the feedback unit 304 to receive the feedback signal V_{FB}. The off timer 309 generates the minimum off time signal Sₘᵢₙ based on the logic signal S_{log} and the feedback signal V_{FB}. During the start up of the switching mode power supply 300 or a short circuit condition happens, the inductor current may go very high, and the output voltage is low. The feedback signal V_{FB} is then low as well. The off timer 209 responds to the low feedback signal, and generates a minimum off time signal with longer preset time period, so as to shorten the conduction time of the high-side switch and extend the conduction time of the low-side switch. As a result, the start-up of the switching mode power supply is smoothed.

FIG. 8 schematically shows a detailed configuration of the off timer 309 in the switching mode power supply 300 in FIG. 7 in accordance with an embodiment of the present disclosure. The configuration of the off timer 309 in FIG. 8 is similar to the off timer 209 in FIG. 6. Different to the off timer 209 in FIG. 6, the minimum time preset unit 93 in FIG. 8 further includes a third input terminal coupled to the feedback unit to receive the feedback signal V_{FB}; and wherein the current source 32 is configured to be controlled by the feedback signal V_{FB}. When the feedback signal V_{FB} is low, the current provided by the current source 31 is lower to elongate the preset time period of the minimum off time signal Sₘᵢₙ; and when the feedback signal V_{FB} is high, the current provided by the current source 31 is longer to shorten the preset time period of the minimum off time signal Sₘᵢₙ.

Several embodiment of the foregoing switching mode power supply provide constant peak current mode control with simple function circuitries compared to conventional technique discussed above. Unlike the conventional technique, several embodiments of the foregoing switching mode power supply adopt a current reference signal to control the ON/OFF status of the high-side switch and the low-side switch, so when the load is light, the switching frequency is reduced, which increases the system efficiency. In addition, several embodiments of the foregoing switching mode power supply adjust the current reference signal to a lower value when the switching mode power supply 100 enters light load condition, which reduces the output voltage ripple.

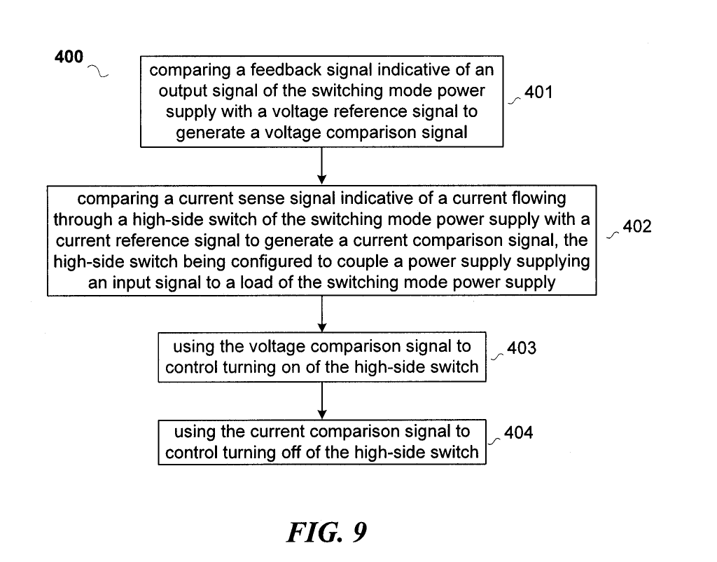

FIG. 9 schematic shows a flowchart 400 of a method for a switching mode power supply in accordance with an embodiment of the present disclosure. The method comprises: step 401, comparing a feedback signal indicative of an output signal of the switching mode power supply with a voltage reference signal to generate a voltage comparison signal; step 402, comparing a current sense signal indicative of a current flowing through a high-side switch of the switching mode power supply with a current reference signal to generate a current comparison signal, the high-side switch being configured to couple a power supply supplying an input signal to a load of the switching mode power supply; step 403, using the voltage comparison signal to control turning on of the high-side switch; and step 404, using the current comparison signal to control turning off of the high-side switch.

In one embodiment, the method further comprises generating a minimum off time signal; generating a logic AND signal by making logic AND with the voltage comparison signal and the minimum off time signal; and using the logic AND signal instead of the voltage comparison signal to control turning on of the high-side switch.

In one embodiment, the method further comprises adjusting the current reference signal to a lower value when the switching mode power supply enters light load condition.

While specific embodiments of the present disclosure have been provided, it is to be understood that these embodiments are for illustration purposes and not limiting. Many additional embodiments will be apparent to persons of ordinary skill in the art reading this disclosure.

I/we claim:

1. A switching mode power supply, comprising:
an input port configured to receive an input signal;
an output port configured to provide an output signal;
a power stage having a first input terminal, a second input terminal, and an output terminal, the first input terminal being coupled to the input port to receive the input signal, the second input terminal being coupled to a driver to receive a driving signal, and based on the input signal and the driving signal, the power stage generates a switching signal at the output terminal;
an inductor having a first terminal and a second terminal, the first terminal being coupled to the output terminal of the power stage to receive the switching signal, and the second terminal being coupled to the output port;
an output capacitor coupled between the output port and a reference ground;
a feedback unit coupled to the output port to generate a feedback signal indicative of the output signal;
a voltage comparator having a first input terminal, a second input terminal, and an output terminal, wherein the first input terminal is coupled to the feedback unit to receive the feedback signal, the second input terminal is coupled to a voltage reference signal, and wherein based on the feedback signal and the voltage reference signal, the voltage comparator generates a voltage comparison signal at the output terminal;
a current comparator having a first input terminal, a second input terminal, and an output terminal, wherein the first input terminal is configured to receive a current sense signal indicative of a current flowing through the power stage, the second input terminal is configured to receive a current reference signal, and wherein based on the current sense signal and the current reference signal, the current comparator generates a current comparison signal at the output terminal;
a logic unit having a first input terminal, a second input terminal, and an output terminal, wherein the first input terminal is coupled to the output terminal of the voltage comparator to receive the voltage comparison signal, the second input terminal is coupled to the output terminal of the current comparator to receive the current comparison signal, and wherein based on the voltage comparison signal and the current comparison signal, the logic unit generates a logic signal at the output terminal; and
the driver coupled to the logic unit to receive the logic signal, and wherein based on the logic signal, the driver generates the driving signal to control the power stage.

2. The switching mode power supply of claim 1, wherein the power stage comprises a high-side switch and a low-side switch coupled in series.

3. The switching mode power supply of claim 1, wherein the logic unit comprises a RS flip-flop.

4. The switching mode power supply of claim 1, wherein the feedback unit comprises a first resistor and a second resistor coupled in series between the output port and the reference ground; and wherein the feedback signal is provided at the conjunction of the first resistor and the second resistor.

5. The switching mode power supply of claim 1, wherein the current reference signal is adjustable.

6. The switching mode power supply of claim 5, wherein the current reference signal is adjusted to a lower value when the switching mode power supply enters light load condition.

7. A switching mode power supply, comprising:
an input port configured to receive an input signal;
an output port configured to provide an output signal;
a power stage having a first input terminal, a second input terminal, and an output terminal, the first input terminal being coupled to the input port to receive the input signal, the second input terminal being coupled to a driver to receive a driving signal, and based on the input signal and the driving signal, the power stage generates a switching signal at the output terminal;
an inductor having a first terminal and a second terminal, the first terminal being coupled to the output terminal of the power stage to receive the switching signal, and the second terminal being coupled to the output port;
an output capacitor coupled between the output port and a reference ground;
a feedback unit coupled to the output port to generate a feedback signal indicative of the output signal;
a voltage comparator having a first input terminal, a second input terminal, and an output terminal, wherein the first input terminal is coupled to the feedback unit to receive the feedback signal, the second input terminal is coupled to a voltage reference signal, and wherein based on the feedback signal and the voltage reference signal, the voltage comparator generates a voltage comparison signal at the output terminal;
an off timer coupled to a logic unit to receive a logic signal, and wherein based on the logic signal, the off timer generates a minimum off time signal;
a logic AND circuit having a first input terminal, a second input terminal, and an output terminal, wherein the first input terminal is coupled to the output terminal of the voltage comparator to receive the voltage comparison signal, the second input terminal is coupled to the off timer to receive the minimum off time signal, and wherein based on the voltage comparison signal and the minimum off time signal, the logic AND circuit generates a logic AND signal;
a current comparator having a first input terminal, a second input terminal, and an output terminal, wherein the first input terminal is configured to receive a current sense signal indicative of a current flowing through the power stage, the second input terminal is coupled to a current reference signal, and wherein based on the current sense signal and the current reference signal, the current comparator generates a current comparison signal at the output terminal;
the logic unit having a first input terminal, a second input terminal, and an output terminal, wherein the first input terminal is coupled to the output terminal of the logic AND circuit to receive the logic AND signal, the second input terminal is coupled to the output terminal of the current comparator to receive the current comparison signal, and wherein based on the logic AND signal and the current comparison signal, the logic unit generates the logic signal at the output terminal; and
the driver coupled to the logic unit to receive the logic signal, and wherein based on the logic signal, the driver generates the driving signal to control the power stage.

8. The switching mode power supply of claim 7, wherein the power stage comprises a high-side switch and a low-side switch coupled in series.

9. The switching mode power supply of claim 7, wherein the logic unit comprises a RS flip-flop.

10. The switching mode power supply of claim 7, wherein the feedback unit comprises a first resistor and a second resistor coupled in series between the output port and the reference ground; and wherein the feedback signal is provided at the conjunction of the first resistor and the second resistor.

11. The switching mode power supply of claim 7, wherein the current reference signal is adjustable.

12. The switching mode power supply of claim 11, wherein the current reference is adjusted to be a lower value when the switching mode power supply enters light load condition.

13. The switching mode power supply of claim 7, wherein the off timer comprises:
a short pulse generator configured to receive the logical signal and generate a short pulse signal based thereupon;
a second logic unit having a first input terminal, a second input terminal, and an output terminal, wherein the first input terminal is coupled to the short pulse generator to receive the short pulse signal, the second input terminal is configured to receive a minimum time preset signal, and based on the short pulse signal and the minimum time preset signal, the second logic unit generates a second logic signal; and
a minimum time preset unit having a first input terminal and a second input terminal, wherein the first input terminal is coupled to the output terminal of the second logic unit to receive the second logic signal, the second input terminal is configured to receive a time reference signal, wherein based on the second logic signal and the time reference signal, the minimum time preset unit generates the minimum time preset signal at the output terminal; and wherein
the minimum off time signal is provided at the output terminal of the second logic unit.

14. The switching mode power supply of claim 13, wherein the minimum time preset unit comprises:
a comparator having a first input terminal, a second input terminal, and an output terminal, wherein the first input terminal is coupled to the time reference signal;
a reset switch, a current source and a capacitor coupled in parallel between the second input terminal of the comparator and the reference ground to provide a voltage across the capacitor to the second input terminal of the comparator, wherein
the comparator generates the minimum time preset signal at its output terminal based on the voltage across the capacitor and the time reference signal; and wherein
the reset switch further having a control terminal coupled to the output of the second logic unit to receive the second logic signal.

15. The switching mode power supply of claim 14, wherein the minimum time preset unit further includes a third input terminal coupled to the feedback unit to receive the feedback signal; and wherein the current source is configured to be controlled by the feedback signal.

16. The switching mode power supply of claim 15, wherein
when the feedback signal is low, the current provided by the current source is lower to elongate the preset time period of the minimum off time signal; and
when the feedback signal is high, the current provided by the current source is longer to shorten the preset time period of the minimum off time signal.

17. The switching mode power supply of claim 7, wherein the second logic unit comprises a RS flip-flop.

18. A method used in a switching mode power supply, comprising:
comparing a feedback signal indicative of an output signal of the switching mode power supply with a voltage reference signal to generate a voltage comparison signal;
comparing a current sense signal indicative of a current flowing through a high-side switch of the switching mode power supply with a current reference signal to generate a current comparison signal, the high-side switch being configured to couple a power supply supplying an input signal to a load of the switching mode power supply;
using the voltage comparison signal to control the turning on of the high-side switch; and
using the current comparison signal to control the turning off of the high-side switch.

19. The method of claim 18, further comprising:
generating a minimum off time signal;
generating a logic AND signal by making logic AND with the voltage comparison signal and the minimum off time signal; and
using the logic AND signal instead of the voltage comparison signal to control the turning on of the high-side switch.

20. The method of claim 18, further comprising:
adjusting the current reference signal to a lower value when the switching mode power supply enters light load condition.
